(19) United States
(12) Patent Application Publication
(10) Pub. No.: US 2013/0258508 A1
(43) Pub. Date: Oct. 3, 2013

(54) LENS MODULE AND METHOD FOR ASSEMBLING THE LENS MODULE

(71) Applicant: CHIEN-CHUN WANG, Tu-Cheng (TW)

(72) Inventor: CHIEN-CHUN WANG, Tu-Cheng (TW)

(21) Appl. No.: 13/660,964

(22) Filed: Oct. 25, 2012

(30) Foreign Application Priority Data
Mar. 28, 2012 (TW) 101110705

(51) Int. Cl. G02B 7/02; B32B 37/06

(52) U.S. Cl. 359/830; 156/272.2

(57) ABSTRACT

A method for assembling a lens module includes the following steps. Firstly, a lens barrel, at least one optical element, a spacer ring and a fixing ring are provided. The spacer ring includes an annular projection along a circumference of the spacer ring. The fixing ring includes a pipe-shaped film and a glue encapsulated in the pipe-shaped film. The film is made of polylactic acid and light decomposition agent. Secondly, the at least one optical element and the spacer ring are put into the barrel, with an annular groove defined between the projection and the barrel. Thirdly, the fixing ring is placed in the groove. Fourthly, the fixing ring is illuminated and the film is melted to let the glue fill the groove. Finally, the glue is cured to fix the spacer ring and the at least one optical element in the barrel.

### BACKGROUND

1. Technical Field

The present invention relates to a method for assembling a lens module and a related lens module.

2. Description of Related Art

During a lens module assembly process, glue is required to fix an optical element firmly in a barrel. Small needles are generally employed to inject and dispense the glue as the lens module become more compact. However, the glue is easily blocked in the small needles, which decreases the efficiency of the assembly process.

Therefore, what is needed is a method for assembling a lens module which can overcome the above mentioned shortcomings.

### BRIEF DESCRIPTION OF THE DRAWINGS

FIG. 1 is a schematic view of an assembled lens module according to a first embodiment.

FIGS. 2-5 are schematic views showing successive steps of a method for assembling a lens module according to a second embodiment.

FIG. 6 is a sectional view of a fixing ring according to a third embodiment.

FIG. 7 is a sectional view of a fixing ring according to a fourth embodiment.

FIG. 8 is a sectional view of a fixing ring according to a fifth embodiment.

### DETAILED DESCRIPTION

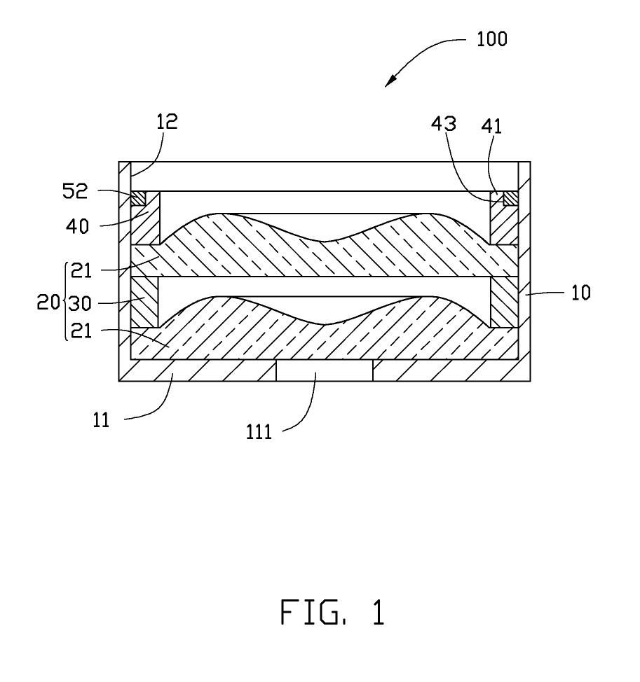

Referring to FIG. 1, a lens module 100 according to a first embodiment is shown. The lens module 100 includes a lens barrel 10, a lens group 20, a spacer ring 40 and a fixing element 52. The lens barrel 10 includes a first end part 11 defining a light through hole 111 and a second end part 12 opposite to the first end part 11. The spacer ring 40 and the lens group 20 are received in the lens barrel 10. The optical axis of the lens module 100 is aligned with a central axis of the light through hole 111. The lens group 20 includes two lenses 21 and an intermediate ring 30. The intermediate ring 30 is sandwiched between the two lenses 21 and is used to protect the optical parts of the two lenses 21 from friction damage. The intermediate ring 30 is a hollow circular ring. One of the two lenses 21 touches the first end part 11. The other one of the two lenses 21 touches the spacer ring 40. The spacer ring 40 has an annular projection 41 along the circumference of the spacer ring 40. The annular projection 41 extends away from the lens group 20. The annular projection 41 and the lens barrel 10 cooperatively form an annular groove 43 therebetween. The annular groove 43 is close to the second end part 12. The fixing element 52 is located in the annular groove 43 and is used to fix the spacer ring 40 and the lens group 20 in the lens barrel 10. The fixing element 52 can be heat-curable glue or light-curable glue.

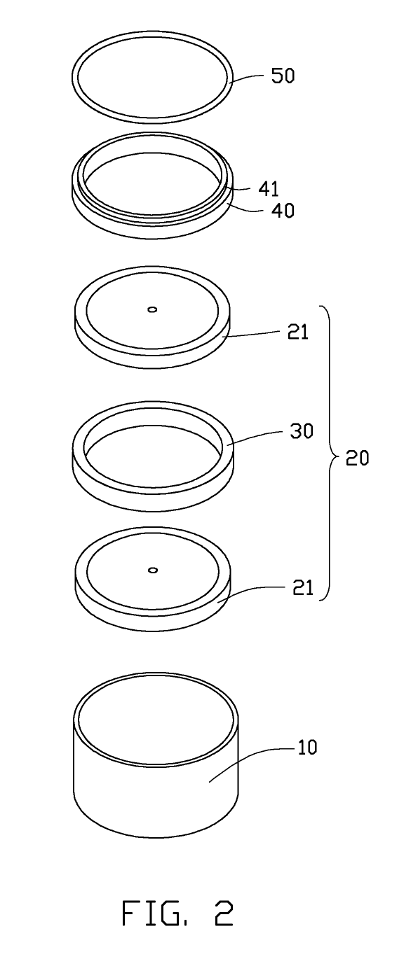

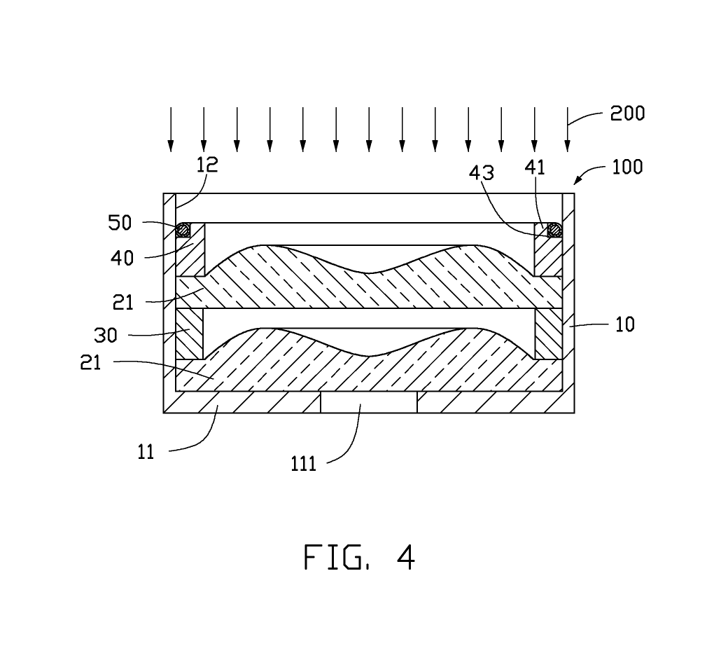

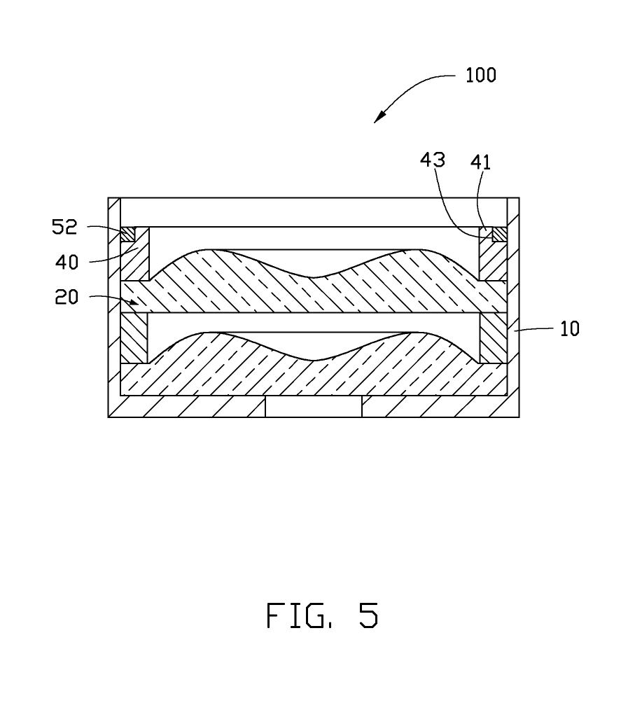

Referring to FIGS. 2-5, a second embodiment of a method for assembling the lens module 100 is shown. The method includes steps described as follows.

In step 1, a lens barrel 10, a lens group 20, a spacer ring 40 and a fixing ring 50 are provided. The lens group includes two lenses 21 and an intermediate ring 30 sandwiched between the two lenses 21.

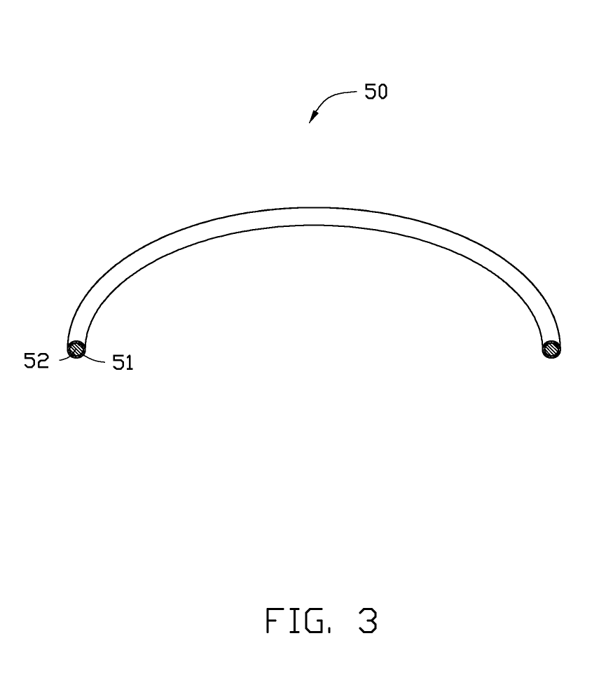

In step 2, the lens group 20 and the spacer ring 40 are sequentially put into the lens barrel 10. The annular projection 41 of the spacer ring 40 faces away from the lens group 20. The annular projection 41 and the lens barrel 10 cooperatively form the annular groove 43 therebetween. The fixing ring 50 is placed in the groove 43. Referring to FIG. 3, the fixing ring 50 includes a pipe-shaped film 51 and a glue 52 encapsulated in the pipe-shaped film 51. In this embodiment, the cross section of the fixing ring 50 is substantially round.

The film 51 is made from polylactic acid and a light decomposition agent. The major component of the film 51 is the light decomposition agent, and the film 51 is thin. Light decomposition agent is sensitive to UV light having the wavelength range of about 290 nm to about 320 nm. The film 51 can be photolyzed when struck by the UV light.

In step 3, the fixing ring 50 is illuminated by the UV light to melt the film 51 and let the glue run into the annular groove 52. In this step, a UV light source 200 is provided. The fixing ring 50 is illuminated by the UV light source 200 having the wavelength range of about 290 nm to about 320 nm. The film 51 is melted and the glue 52 encapsulated in the film 51 flows into the annular groove 43 to fill the annular groove 43.

In step 4, the glue 52 in the annular groove 43 is cured. The glue 52 can be a heat-curable glue or an ultraviolet-curable glue. If the glue 52 is a heat-curable glue, a heat source (not shown) is provided to cure the glue 52 at a temperatures of about 80° C. If the glue 52 is an ultraviolet-curable glue, an ultraviolet light source is provided to cure the glue 52. The wavelength of the UV light for curing is between about 320 nm to about 400 nm and the curing time is about 15 seconds.

The assembling method simplifies the lens module assembly process by using the fixing ring 50 to fix the lens group 20 in the lens barrel 10 and avoids a glue dispensing process.

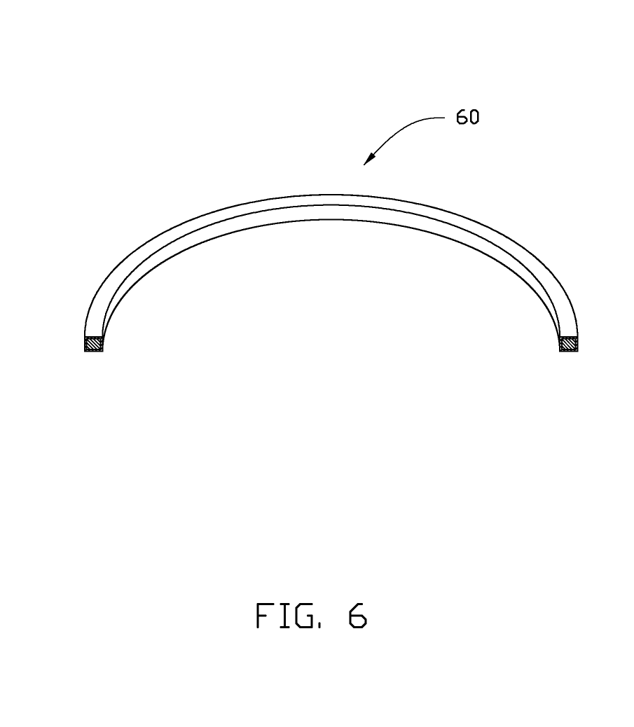

Referring to FIG. 6, a fixing ring 60 according to a third embodiment is shown. The difference between the fixing ring 60 and the fixing ring 50 in the second embodiment is that the cross section of the fixing ring 60 is substantially square.

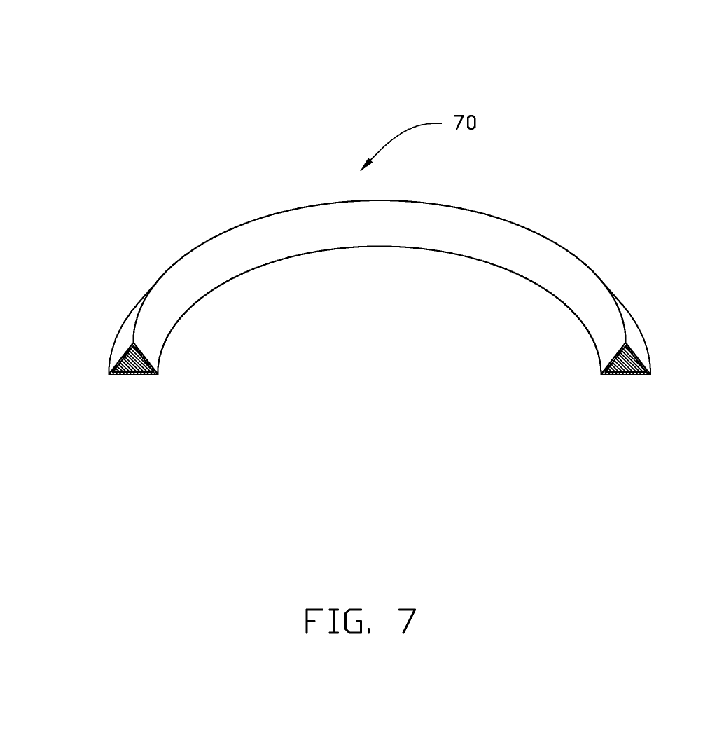

Referring to FIG. 7, a fixing ring 70 according to a fourth embodiment is shown. The difference between the fixing ring 70 and the fixing ring 50 in the second embodiment is that the cross section of the fixing ring 70 is substantially triangular.

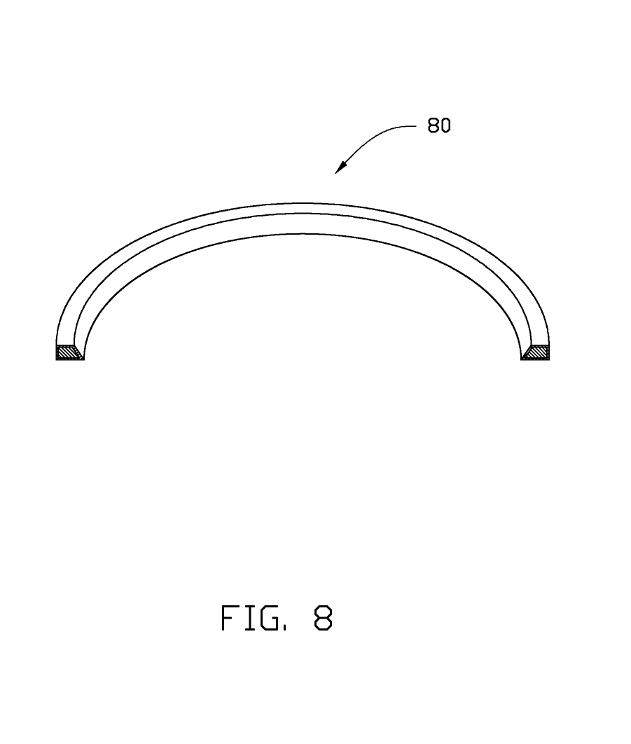

Referring to FIG. 8, a fixing ring 80 according to a fifth embodiment is shown. The difference between the fixing ring 80 and the fixing ring 50 in the second embodiment is that the cross section of the fixing ring 80 is substantially trapezoidal.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A method for assembling a lens module, comprising:
providing a lens barrel, at least one optical element, a spacer ring and a fixing ring, the spacer ring having an annular projection along a circumference of the spacer ring, the fixing ring comprising a pipe-shaped film and a glue encapsulated in the pipe-shaped film, the film made from polylactic acid and light decomposition agent;
putting the at least one optical element and the spacer ring into the lens barrel, the annular projection facing away from the at least one optical element, the annular projection and the lens barrel cooperatively defining an annular groove therebetween;
putting the fixing ring in the annular groove;
illuminating the fixing ring to melt the film and let the glue run into the annular groove to fill the annular groove; and
curing the glue in the annular groove.

2. The method of claim 1, wherein a cross-section of the fixing ring is substantially square.

3. The method of claim 1, wherein a cross-section of the fixing ring is substantially round.

4. The method of claim 1, wherein a cross-section of the fixing ring is substantially triangular.

5. The method of claim 1, wherein a cross-section of the fixing ring is substantially trapezoidal.

6. The method of claim 1, wherein the glue encapsulated in the pipe-shaped film is heat-curable glue or light-curable glue.

7. The method of claim 1, wherein the glue is the ultraviolet curable glue and is cured by an ultraviolet source.

8. The method of claim 7, wherein the ultraviolet source emits ultraviolet light having a wavelength in a range from 320 nanometers (nm) and 400 nm for curing the glue.

9. The method of claim 1, wherein an ultraviolet light is used to illuminate the fixing ring to melt the film, and the ultraviolet light has a wavelength in a range from 290 nm to 320 nm.

10. The method of claim 1, wherein the glue is heat curable glue and is cured by a heating source.

11. A lens module, comprising:
a lens barrel;
at least one optical element received in the lens barrel;
a spacer ring received in the lens barrel, the spacer ring having an annular projection along a circumference of the spacer ring, the annular projection facing away from the at least one optical element, the annular projection and the lens barrel cooperatively defining an annular groove therebetween;
a fixing element filled in the annular groove and fixing the spacer ring and the at least one optical element in the lens barrel.

12. The lens module of claim 11, wherein the fixing element comprises heat-curable glue or light-curable glue.
